(19) United States
(12) Patent Application Publication
(10) Pub. No.: US 2014/0234097 A1
(43) Pub. Date: Aug. 21, 2014

(54) HORIZONTAL-TYPE WIND TURBINE WITH AN UPSTREAM DEFLECTOR

(71) Applicant: CALIFORNIA INSTITUTE OF TECHNOLOGY, Pasadena, CA (US)

(72) Inventors: Daegyoum Kim, Pasadena, CA (US); Morteza Gharib, Altadena, CA (US)

(73) Assignee: CALIFORNIA INSTITUTE OF TECHNOLOGY, Pasadena, CA (US)

(21) Appl. No.: 14/183,447

(22) Filed: Feb. 18, 2014

Related U.S. Application Data
(60) Provisional application No. 61/766,467, filed on Feb. 19, 2013.

(51) Int. Cl. F03D 1/04

(52) U.S. Cl. CPC F03D 1/04; F05B 2230/30; F05B 2230/60
USPC 415/208.1; 29/428; 29/460

(57) ABSTRACT

Horizontal axis wind turbine (HAWT) systems are described that include a turbine with deflector in front of the turbine in order to change flow encountered by the turbine's blades. Such an arrangement improves turbine efficiency and may be embodied in a range of size scales for numerous wind (or water) power generation applications.

### RELATED APPLICATIONS

This application claims the benefit of and priority to U.S. Provisional Patent Application No. 61/766,467, filed on Feb. 19, 2013, which is incorporated by reference herein in its entirety for all purposes.

### FIELD

The embodiments described herein optionally relate to wind and/or water power generation, particularly electrical power generation.

### BACKGROUND

Extracting electrical power with turbines from wind and water flow offers the potential for tremendous utility. Commercial wind-power operations may group turbines having (i.e., in the case of horizontal-axis turbines) a sweep diameter of its blades of 150 meters (m) or more, producing power upwards of 5 megawatts (MW). Modern composites engineering and computer modeling are currently being employed to realize 10MW turbines.

Small(er) wind turbines find use in a variety of applications including on- or off-grid residences, boats, recreational vehicles (RVs), telecommunications towers, offshore platforms, remote monitoring stations, and others. Such units often have a sweep diameter of one meter or less and may include a directional vane for pointing the turbine blades into the wind.

Smaller yet, MEMs produced turbines (an example produced by WinMEMSTechnologies Co., LTD, a Taiwanese fabrication foundry, having an overall height of 1.8 millimeters (mm)) are leading to the possibility of recharging any of a variety of handheld smartphone and other such devices. It has been proposed that an array of these micro-scale turbines may be integrated into auxiliary electronic device cases for such use. Other configurations and applications of such technology are possible as well.

While constructional techniques and the uses vary between the different scale examples above, the underlying fluid-flow principles are applicable across the entire range or scale of such devices. Studies regarding wind turbine efficiency have been made since 1915 with British scientist Frederick W. Lanchester and later by German physicist Albert Betz who each derived theoretical maximum harvesting efficiency. According to Betz's law, no turbine can capture more than 16/27 (59.3%) of the wind energy passing through its envelope. In practice, wind turbines have achieved 75-80% of such efficiency. Recently, Computational Flow Dynamics (CFD) tools have been applied and have demonstrated agreement between theory and practice.

Needs exist to improve turbine efficiency irrespective of various advances in construction processes (e.g., as enabling super-large and super-small scale turbines) and/or computational tools (e.g., as in CFD accurately predicting efficiency for a given model). The embodiments set forth herein address these needs in any of a range of applications.

### SUMMARY

The energy conversion efficiency of a horizontal-axis wind turbine (HAWT) is improved by certain embodiments hereof by placing a circular (or non-circular) deflector in front of the turbine in order to change flow encountered by its blades. The deflector and turbine can be either concentric or non-concentric.

The deflector may be separately mounted from the turbine. This may be accomplished in connection with a pole, armature or other mount in front of a turbine. Alternatively, the deflector may be attached to a turbine hub or a turbine nacelle. The deflector can rotate or remain stationary with respect to turbine blades. The turbine/deflector combinations may be provided in stand-alone configurations or arrayed in groups or within assemblies or within so-called “wind farm” applications or other constructions.

In operation, fluid flows such that wind is deflected by the deflector surface and a wake region of low pressure and low flow velocity is formed behind the deflector. However, the wind velocity outside the wake region becomes higher than free-stream velocity. This flow acts upon the turbine blades.

The approach is independent of scale. In some examples, the turbine is macro-sized for environmental placement. In other examples, the turbine is micro-sized for portable use. In both varieties, the same essential HAWT type “format” is contemplated. This holds true regardless of how the turbine is instantaneously oriented. In other words, what is meant by a “C” or “horizontal-type” turbine is one in the blades have an axis of rotation horizontal thereto (as compared to an aligned arrangement as present in so-called Vertical Axis Wind Turbine (VAWT) designs).

Likewise, the deflector configuration can have an adaptable shape based on wind condition to maximize power output. At a given wind condition, the deflector should be optimized for its shape, size, and distance from the turbine. In addition, some engraved or protruded patterns on the surface can change the flow field and improve efficiency of the turbine.

The subject turbine constructions, groups or arrays thereof, products to which they may be affixed or incorporated (e.g., as in handheld electronic devices directly incorporating the structures, housings, or cases for such devices incorporating the subject turbine constructions) and methods of use and manufacture are all included within the subject embodiments. Some aspects are described herein, others will be appreciated by those with skill in the art in reference to the present disclosure.

### BRIEF DESCRIPTION OF THE DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIGS. 1A and 1B are front and side schematic views of first example embodiment of a HAWT system with an upstream deflector.

FIGS. 2A and 2B are front and side schematic views of another example embodiment of a HAWT system with an upstream deflector.

FIGS. 3A and 3B are front and side schematic views of another example embodiment of a HAWT system with an upstream deflector.

FIG. 4 is a perspective view of another example embodiment of a HAWT system with an upstream deflector.

FIG. 5 is a photograph of a HAWT model with a deflector.

FIG. 6 is a plot of the distribution of non-dimensional flow velocity magnitude around a flat rigid disc perpendicular to wind for the model of FIG. 5.

FIGS. 7A and 7B are plots of percentage of power output increase from a HAWT base case without a deflector for variations with an upstream deflector.

### DETAILED DESCRIPTION

Before the present subject matter is described in detail, it is to be understood that this subject matter is not limited to the particular embodiments described, as such are only examples and may, of course, vary. It is also to be understood that the terminology used herein is for the purpose of describing particular embodiments only, and is not intended to be limiting, since the scope of the present disclosure will be limited only by the appended claims.

Furthermore, it should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. Express recitation of every possible combination and substitution is overly burdensome, especially given that the permissibility of each and every such combination and substitution will be readily recognized by those of ordinary skill in the art upon reading this description.

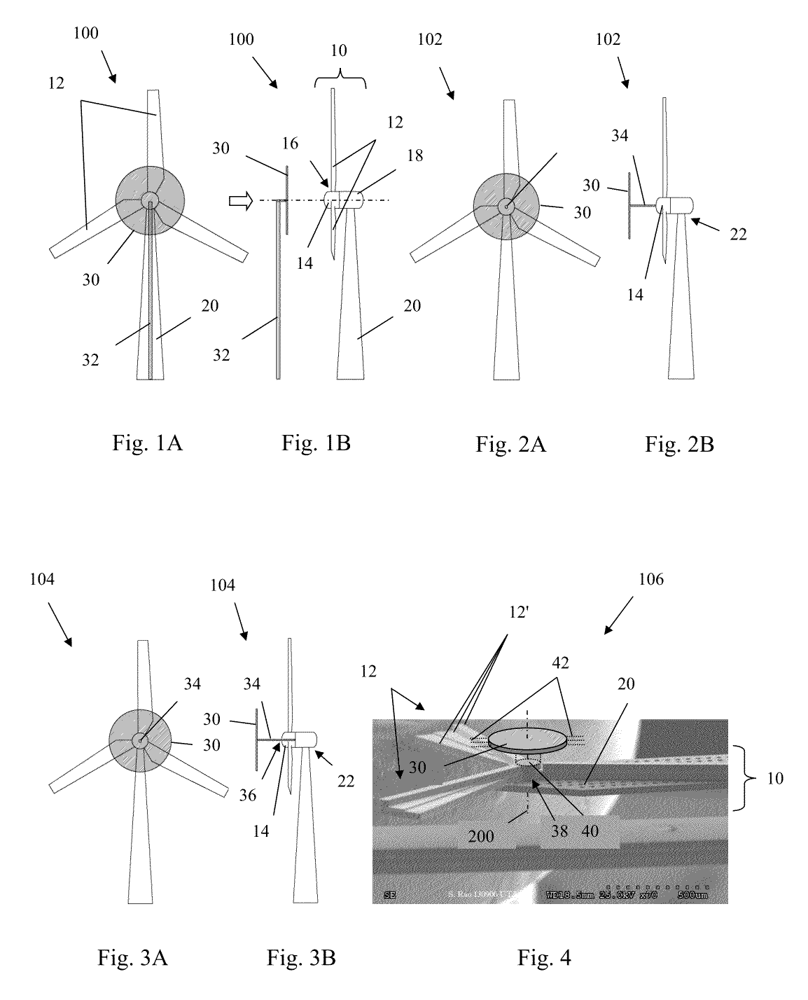

Per above, FIGS. 1A and 1B are front and side schematic views of an example embodiment of a HAWT system 100 with an upstream deflector. Here, turbine 10 includes blades or rotors 12 mounted to rotate around an axis 200 perpendicular thereto. The blades meet at a hub 14. A blade pitch control mechanism 16 may be interposed or form a junction there between. A controller, generator, brake assembly, shaft(s) and other gearing componentry (not shown) may be housed within nacelle 18 supported by tower 20. A deflector 30 is mounted on a pole 32 (alternatively a tower, piling or stanchion) in front of a turbine 10. The “upstream” orientation of deflector 30 is illustrated by the direction in which turbine 10 is oriented (i.e., typically into the wind as indicated by the flow arrow).

FIGS. 2A and 2B illustrate another example embodiment of a HAWT system 102 in which the deflector 30 is connected (via a spacing post, strut or stanchion 34) to the turbine hub 14. So-situated, these components may easily turn together (e.g., into the wind). As such, a yaw drive is 22 is advantageously interposed between nacelle 18 and the support tower 20. In another example embodiment of a HAWT system 104 shown in FIGS. 3A and 3B the deflector 30 is connected to the nacelle 18 to the nacelle (again via a spacing post, strut or stanchion 34) through an inner hole 36 of the hub.

Essentially, these embodiments differ in that the deflector in the FIG. 2A/2B embodiment rotates with the blades whereas the deflector in the FIG. 3A/3B embodiment does not. In any case, they offer potential (with addition of a linear actuation stage for or along post 34) for easily modifying the distance between the deflector and turbine blades for optimal performance in varying wind conditions.

FIG. 4 is a perspective view of another example embodiment of a HAWT system 106 with an upstream deflector 30. As can be seen in the Scanning Electron Microscope (SEM) image, the turbine 10 is a MEMs type construction. The turbine blades 12 have a rough foil shape defined in layers 12′. Nevertheless, the fundamental HAWT architecture differs little from the embodiments above in that the blades rotate around an axis 200 perpendicular thereto, while supported on a tower feature 20 and secured via a capped shaft 38. As indicated by the dotted line, a face 40 (or other support features) of the shaft may extend to support the deflector 30 included in the figure. Alternatively, the deflector may be held by side support(s) 42 also indicated by the dotted line. These side supports may reach and/or integrate with a housing or case body into which an array of the subject systems 106 may be set.

Apart from the deflector augmentation as taught herein, the underlying turbine has been reported as a product of a University of Texas at Arlington as collaboration between research associate Smitha Rao and electrical engineering professor J. C. Chiao. The turbine design employs conventional wafer-scale semiconductor device layouts utilizing planar multilayer nickel alloy electroplating techniques as by WinMEMS Technologies Co., and was reported to have been tested September 2013 in J. C. Chiao's lab.

Such micro-windmills can be made in an array using the batch processes. The same holds true for production of the deflectors and/or deflectors in combination with the micro-windmills as shown and described in connection with FIG. 4 or otherwise. Given such batch processing techniques, while these micro-windmill/deflector type devices may be incorporated and/or used in or with sleeve or casing members for portable electronic devices (as referenced above), they may also feasibly be constructed or attached to flat panels by the thousands and even up into the millions. Such panels may be employed in or for covering structures ranging from houses as exterior siding/paneling or for window coverings/shutters, to Recreation Vehicles (RVs), Electric Vehicles (EVs), boats, weather stations and even HAWT towers for further augmenting their energy production in a co-located type of power generation arrangement. In another co-located arrangement, the panels may be applied to or used as (otherwise inactive) solar power panel wind shields elements. Still further, the panels may be arrayed on or hung from trees or power poles to leverage existing infrastructure. Likewise they may situated (originally or retrofit) to harvest otherwise wasted wind energy from HVAC unit exhaust systems. In any case, related discussion is presented at http://www.uta.edu/news/releases/2014/01/microwindmill-rao-chiao.php (Jan. 10, 2014), which article is incorporated by reference herein in its entirety for all purposes.

Regardless, in all of these embodiments the size and placement of the deflector can be varied to optimize performance for the given application. Deflector position or placement relative to the turbine blades may be modified in “real time” (e.g., every second or less) using computer control and feedback (in which case the system may include such processing means on board or it may be remotely provided via data connection to a local or remote network (e.g., the cloud). Alternatively, the systems components may be fixed in relation to one another and designed in accordance with teachings represented by the work below.

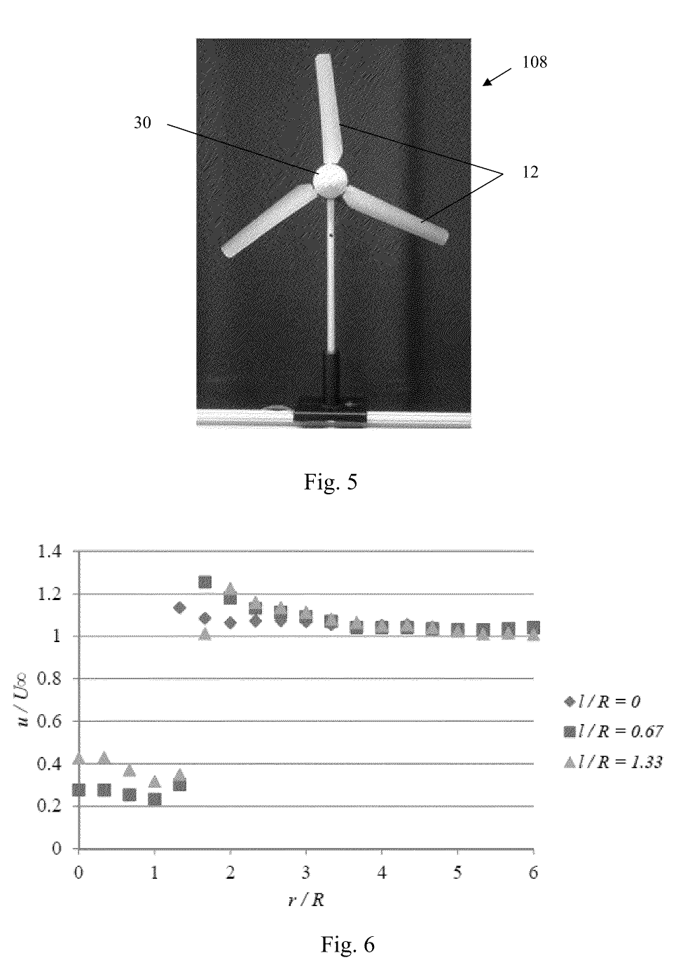

FIG. 5 is a photograph of a HAWT model 108 with a deflector 30 in the form of a 3 inch diameter flat rigid disc and a blade 12 sweep area of 14 inches. For experiment, deflectors with different diameters and different distances from the turbine were used to determine if there is an optimized configuration for the power output in airflow.

In hot-wire tests with a rigid flat disc perpendicular to wind direction, the mean velocity magnitude of the flow just outside the wake region increased substantially over the free-stream velocity. With the setup pictured in FIG. 5, wind velocity magnitude was measured in the radial direction on three different planes behind the disc. Such activity is plotted in FIG. 6 showing a distribution of non-dimensional velocity magnitude, u/U∞, around the disc perpendicular to wind direction (free-stream wind speed U∞=4.9 msec) with r as the radial coordinate from the disc center of overall disc radius R and l as the streamwise distance of a measurement plane (where the turbine blades could be placed to optimize flow speed) from the disc.

Thus, the portion of blade outside the wake region can generate higher torque because of increased wind speed. The deflector displaces wind from the inner part of the blade to the outer part with longer moment arm, which results in higher torque generation. Moreover, the blades encounter higher wind speed and they can rotate with higher rotating speed as compared to a normal horizontal wind turbine without a deflector. Accordingly, the power output of the embodiments of the HAWT systems should exceed that of a system without a deflector.

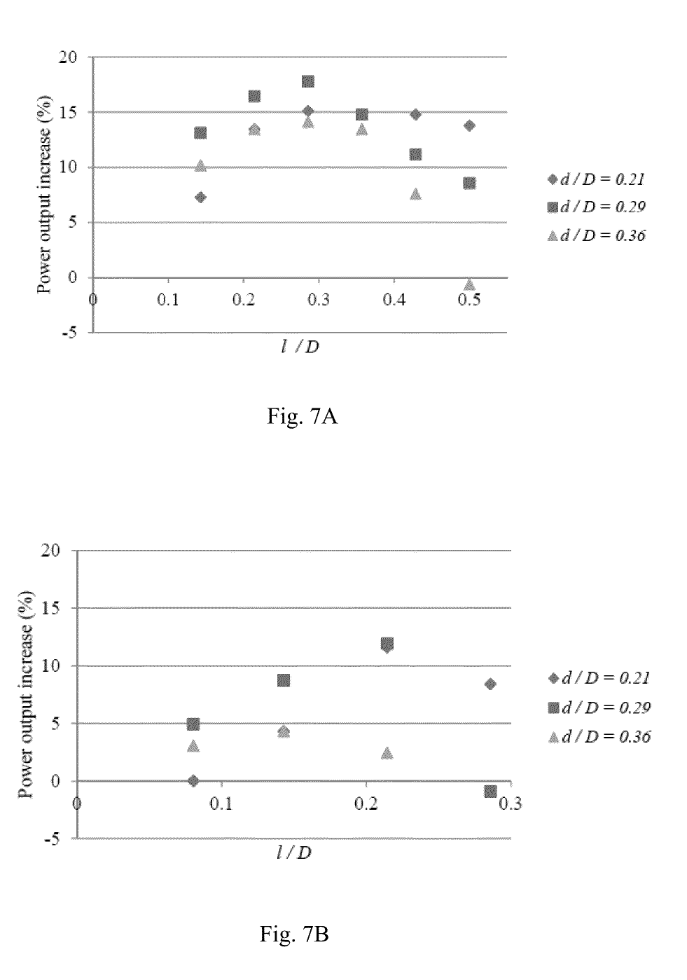

FIGS. 7A and 7B illustrate such improvement. The figures plot percentage of power output increase from a base case (i.e., the turbine shown in FIG. 5 without a deflector) for variations with a deflector (i.e., as actually shown in FIG. 5) where deflector diameter d and distance from the turbine l were varied with D as the diameter of blade swept area. As shown in FIG. 7A, compared to the case without a deflector, power output increased about 18 percent at maximum when a deflector was mounted separately in front of the turbine. As shown in FIG. 7B for a case with a deflector attached to rotate with the turbine hub, maximum power output increase was about 12 percent.

The subject methods may variously include assembly and/or installation activities associated with system use and product (e.g., electricity) produced therefrom. Regarding any such methods, these may be carried out in any order of the events which is logically possible, as well as any recited order of events.

Furthermore, where a range of values is provided (e.g., as in the plots or graphs shown), it is understood that every intervening value, between the upper and lower limit of that range and any other stated or intervening value in the stated range is encompassed within the present disclosure. Regarding other numerical values and ratios, these may be taken from and/or extrapolated from the included plots or graphs. As such, these data provide direct antecedent basis for the claims as represented below.

Likewise, while HAWTs with three blades are shown and described above, this number is not exclusive. The subject constructions may include turbines with only two or four or more blades. Also, it is contemplated that any optional feature of the embodiments described may be set forth and claimed independently, or in combination with any one or more of the features described herein.

Reference to a singular item includes the possibility that there are a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element--irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the different embodiments or aspects described herein is not to be limited to the examples provided and/or the subject specification, but rather only by the scope of the issued claim language. It should be understood, that the description of specific example embodiments is not intended to limit the present subject matter to the particular forms disclosed, but on the contrary, this patent is to cover all modifications and equivalents as illustrated, in part, by the appended claims.

1. A horizontal axis wind turbine (HAWT) system comprising:
a turbine including a plurality of blades having a sweep diameter; and
a deflector positioned in front of the blades by a distance and having a body diameter less than the sweep diameter.

2. The HAWT system of claim 1, further comprising a turbine nacel.

3. The HAWT system of claim 1, further comprising a turbine support.

4. The HAWT system of claim 1, wherein the deflector is centered relative to the blades.

5. The HAWT system of claim 1, wherein the deflector is a circular disk.

6. The HAWT system of claim 1, wherein the deflector is supported independently of the turbine.

7. The HAWT system of claim 1, wherein the deflector is supported by the turbine.

8. The HAWT system of claim 1, wherein the deflector is connected to rotate with the blades.

9. The HAWT system of claim 1, wherein the deflector is supported so that it does not rotate with the blades.

10. The HAWT system of claim 1, wherein at least about a 7% gain in efficiency is achieved by inclusion of the deflector relative to an otherwise identical system without the deflector.

11. The HAWT system of claim 10, wherein the efficiency gain is up to about 20%.

12. The system of claim 1, wherein a deflector body diameter to turbine sweep diameter ratio is at least about 0.2.

13. The system of claim 12, wherein the diameter ratio is up to about 0.4.

14. The system of claim 12, wherein the diameter ratio is about 0.3.

15. The system of claim 12, wherein a ratio of the distance between the blades and deflector and the deflector body diameter is between about 0.15 and 0.5.

16. The system of claim 1, wherein a deflector body diameter to turbine sweep diameter ratio is about 0.2 and a ratio of the distance between the blades and deflector and the deflector body diameter is between about 0.2 and 0.5.

17. The system of claim 1, wherein a deflector body diameter to turbine sweep diameter ratio is about 0.3 and a ratio of the distance between the blades and deflector and the deflector body diameter is between about 0.15 and 0.35.

18. The system of claim 1, wherein a deflector body diameter to turbine sweep diameter ratio is about 0.4 and a ratio of the distance between the blades and deflector and the deflector body diameter is between about 0.2 and about 0.4.

19. The system of claim 18, wherein the deflector body diameter to turbine sweep diameter ratio is 0.36.

20. A method of horizontal axis wind turbine (HAWT) system production, the method comprising:
providing a HAWT construction; and
setting a deflector upstream of the HAWT construction to define at least one HAWT system.

21. The method of claim 20, employing electroplating construction techniques for at least the HAWT construction.

22. The method of claim 21, wherein at least the HAWT construction comprises a Nickel alloy.

23. The method of claim 20, wherein the setting is by retrofitting an existing HAWT construction with the deflector.

24. The method of claim 20, wherein an array of the HAWT systems is produced.

25. The method of claim 20, wherein the setting increases the HAWT construction efficiency by at least about 7%

26. The method of claim 20, wherein the setting increases the HAWT construction efficiency up to about 20%.
